(19) United States
(12) Patent Application Publication
(10) Pub. No.: US 2018/0310538 A1
(43) Pub. Date: Nov. 1, 2018

(54) FISHING LURE DEVICE AND METHOD

(71) Applicant: Eric David Supinski, Granby, MA (US)

(72) Inventor: Eric David Supinski, Granby, MA (US)

(21) Appl. No.: 15/962,565

(22) Filed: Apr. 25, 2018

Related U.S. Application Data
(60) Provisional application No. 62/490,347, filed on Apr. 26, 2017.

(51) Int. Cl. A01K 85/14; A01K 85/10; A01K 85/01

(52) U.S. Cl. CPC A01K 85/14; A01K 85/01; A01K 85/10

(57) ABSTRACT

A fishing lure device and method of use are disclosed. The lure device may include a blade component, which may define one or more openings configured for attachment of a wire or other elongated element. The wire may further connect to a lure body and may also extend through the lure body and form a hook. The wire connects to the blade component so as to allow for at least partial rotation and may allow for oscillation, which may simulate the motion of fish. The blade may include an indentation or other feature which may allow for more realistic oscillation and may also allow the wire and attached lure body to be substantially in line with the primary plane of the blade. The blade may also define openings for the attachment of pivots arms which may include rattles or beads and may also include flutter components or reflective features.

### BACKGROUND

This application claims the priority of U.S. Provisional Patent Application No. 62/490,347 filed on Apr. 26, 2017, the disclosure of which is incorporated herein in its entirety.

The present disclosure relates generally to a fishing lure device and method of use. More particularly, the present disclosure relates to fishing lure components and assemblies which are configured to and include features to simulate the motion or appearance of one or more prey fish to predator fish.

Various types of fishing lures are known in the art. Throughout fishing, a primary need that is present is to be able to provide a lure and present it to fish in such a way as to be attractive to the types of fish which are intended to be caught. A prominent means of attracting desired fish is by configuring the lure so as to simulate prey upon which the desired fish, as a predator, feeds, whether by size and shape or by motion within the water. Though many designs and methods have been attempted, including using lures which are shaped to appear similar to a fish, both professional and amateur fishers continue to seek improved lures which may be more effective at attracting and catching desirable fish.

Current lures and methods of use of lures continue to face issues of insufficiently or not accurately simulating the motion of prey fish, and often do not fully account for other senses of fish, including hearing. Current lures also have difficulty in simulating a school of fish, which may be more desirable to a predator. Current lures also have difficulty in simulating the appearance of larger fish or specific types of fish, as perceived by predator fish, while maintaining manageable mass and effective motion within the water. Current lures are also prone to snagging on a line or other elements within the water or not maintaining proper orientation of motion relative to the hook and main body of the lure. Current lures can also be prone to breaking when a fish is caught on a hook, thus separating that hook from other portions of the lure or the line itself.

### SUMMARY

The disclosure relates to an improved fishing lure device and method of use. More specifically, the disclosure relates to an improved device and method of use of a fishing lure assembly and associated components to simulate the motion of one or more fish and also to reduce the risk of snagging of the line on the lure or breakage or separation of a hook from a lure assembly or fishing line.

In one embodiment, the present invention includes a lure body which may include one or more hooks. The lure body may be substantially cylindrical. It may also be substantially spherical, conical, cubic, or be any shape which may support a hook, or it may be a selectively weighted mass. The lure body may also be configured so as to resemble the shape of one or more fish. The lure body may have a wire or other projection extending substantially forward from a front portion or surface. The projection or wire may also extend from a side surface of the lure body, such as the top of the lure body. The wire or projection may further be connected to a blade, which may be formed into various shapes. The blade may be substantially planar or may include a curve, bend, or other features. The blade may further be connected to a fishing line.

In one embodiment, the wire or projection may be connected to one or more hooks. A hook may extend directly from the wire, from the blade, or from the lure body. The wire may also pass through the lure body, extending and being configured into a hook after exiting from the lure body. In such an embodiment, the hook and assembly may benefit from not being weakened through the hook's connection to the lure body. The hook may be connected to the wire, directly or through another component such as the blade, but may not need to be connected to the line by means of the lure body, which allows the hook to still be connected to the blade and to the fishing line even if the hook becomes separated from the lure body, such as if the lure body breaks. Though a lure body may break when a fish is caught on a hook, such as when a lure body is made from more than one component, the hook may still remain connected to the line by way of the blade and a hooked fish may be retained. One or more additional wires or hooks may be connected to the primary wire, either within the lure body or externally to it. An additional wire or hook may be configured into an at least partial loop or eyelet, though which the primary wire extends, thus restricting motion of the additional wire or hook in at least one direction. A loop or eyelet may be located within an open volume within the lure body.

The wire passing from the blade to the lure body may be of various lengths, thicknesses, and cross-sectional profiles, and may include additional features or elements. A shorter length may be preferable when it is desirable to simulate a single fish or a relatively small fish. A longer length of wire may be used when it is preferable to have a greater distance between the blade and the lure body, such as when simulating a larger fish or when creating the appearance of multiple fish may be desirable. The wire may connect to the blade through a number of means, including a translatable or rotatable connection, such as one which allows for at least partial rotation around an axis relative to the blade. The wire may also connect to the blade so as to allow oscillation in at least one plane relative to the blade or so as to allow motion within multiple planes.

In one embodiment, the wire passes through an opening defined by the blade and is held in place by means of an at least partial loop or eyelet. This loop or eyelet may be a separate component which may be attached to the end of the wire, or the wire may be bent or otherwise formed so as to itself create the loop or other retention feature. In an alternate embodiment, the wire may include an at least partially cylindrical, conical, or spherical feature proximal to the blade. The wire may pass through at least one opening defined by the blade or an element attached to it, while the cylindrical, spherical, or conical feature retains the wire on one side of the blade while also allowing for angular motion of the wire relative to the blade in at least one plane. A loop or eyelet, formed of a portion of the wire proximal to the blade, may also be used similar to the function of the cylindrical, spherical, or conical feature above.

In another embodiment, the wire may connect to the blade by means of a plurality of openings defined by the blade, such as passing through a first opening and then looping or hooking around a second opening. One or both openings may be a complete hole passing through the blade, or may be a partial hole, recess, or slot, defined by the blade. In a further embodiment, the wire may pass through a first hole, such as one which is proximal to the back end of the blade. The wire may pass through from a substantially upper or top surface of the blade, through the first hole, exit through a substantially lower or bottom surface of the blade, and loop up through the blade, exiting through a substantially upper or top surface of the blade through a second opening and forming at least a partial loop proximal to where the wire first entered the blade. The wire, upon looping back, may also be deformed so as to at least partially wrap around another portion of the wire or an attached element. The wire may also be connected to a cylindrical, spherical, or conical feature or may form an eyelet after passing through the second opening in the blade so as to resist disconnection from the blade.

It may be further desirable to have the blade at least partially deformed or indented or recessed along some of a surface between the first hole and the back end of the blade. As described above, if the blade is deformed downward, relative to the wire entering the blade from the top, then this may permit more freedom of motion of the wire relative to the blade. As such, the wire may be able to move or oscillate at least partially side to side or up and down relative to the blade. A true sweeping oscillation, rather than vibration through a small curvature, may be desirable for realistic simulation of the movement of live fish. This may further permit the lure body to movably connect to the blade, and to move while remaining in a more upright orientation than other lures that are currently on the market. This, in turn, can create a more realistic appearance of a fish to predators, as well as more realistically simulating the motion of a fish or multiple fish. There may also, or instead, be a deformation or indenting or recessing of the blade between the first opening and the second opening. Similar deformation in the blade may be used even when the wire connects to the blade through a single opening, such as when an eyelet or spherical or conical feature is used to resist disconnection of the wire from the blade. These features may also reduce the likelihood of the blade or other portions of the lure snagging or otherwise interfering with the fishing line. This can create more natural motion for the lure, while also potentially avoiding damaging or breaking the line. The blade may include multiple indentations or recesses, such as to at least partially receive the wire along one surface of the blade, and at least partially receive a portion of the wire or a retention feature on another surface of the blade, or to accomplish just one of these options. One or more indentations may allow for the wire or for the lure body to stay at least partially within the primary plane of the blade during use.

In one embodiment, the blade may define one or more openings or other features for connection of a fishing line to the blade. A fishing line may be tied to the blade, may pass through one or more openings defined by the blade and be tied in place, or may be attached to a connection feature, such as an eyelet, hook, or wire loop, which connects to the blade.

The blade may be substantially planar, though it may also feature one or more areas or features which may be at least partially deformed, bent, or otherwise configured to extend outside of the primary plane of the blade. In one embodiment, the front portion of the blade may be bent upward or downward. This bend, resulting in material and at least one surface which is at least partially outside of the main plane of the blade, may cause turbulence within the water which may cause oscillations or may otherwise simulate the motion of one or more fish. The bend may be created during stamping, molding, or machining of the blade, or may be created as a secondary operation during or after the manufacture of the blade. The bend may also be a separate component which is attached to the blade so as to extend outside of the primary plane of the blade. A smaller amount of the blade being bent out of the primary plane of the blade, or a completely planar blade, may allow for smoother movement below or at the surface of the water. The blade may also be generally formed into any of a wide range of shapes, relative to a top-down view of the blade. Optional shapes of the blade include, but are not limited to, pentagons, rectangles, circles, ovals, triangles, hexagons, octagons, tear-drop shapes, curved shapes, and other shapes. In one embodiment, the blade is shaped so as to have four sides, with the front and back sides being substantially straight, while the left and right sides are substantially curved, such as forming one or more convex surfaces.

In another embodiment, the blade may also define one or more openings which may allow for attachment of one or more additional components, such as pivot arms. These openings may be located proximal or distal to the center of mass of the blade or the attachment point of the fishing line to the blade. In one embodiment, the blade defines two openings for the attachment of additional components, one on either side of the connection area of the fishing line to the blade.

Various additional components may be attached to the blade, including where such components are attached in a movable, rotatable, translatable, or removable fashion. Components may be attached rotatably, so as to oscillate, or so as to have a substantially or partially free range of motion. Additional components may be supported by an additional wire or other structure which may pass through an opening in the blade. The additional wire may include a substantially spherical end feature, such as a ball bearing or bead, may include a conical feature, eyelet, or may include another feature so as to retain the additional wire connected to the blade in at least one direction of motion of the additional wire. The additional wire may also be deformed so as to prevent the entire additional wire from passing through the opening in at least one direction. The use of such features with the additional wire may create a pivot arm which may move freely and may also create a natural oscillating motion within the water, rather than the vibration of current products on the market.

The additional wire may include an additional component or feature proximal to the end opposite from the blade. In one embodiment, the additional wire is attached to a rattle component or bead. The rattle component may be any structure or subassembly which is configured so as to create a desired noise or vibration under the water. Various materials may be used for the outside or inside of the rattle, including plastic, metal, composites, or combinations thereof. Different materials will create different rattling sounds and vibrations. Different noises or vibrations may be attractive or gain the attention of different predators. As such, different rattles may be used for different environments or desired catches. Different lures may be used when different rattles are desired, or the rattle or additional wire may be removable so as to allow removable connection of the rattle or additional wire to the lure assembly or blade.

In one embodiment, the rattle component may be threaded on, in, or off of the additional wire, which may be a rod, cylinder, or other type of member. The rattle or bead may also be slidably connected to the additional wire, such as through a through-hole in the rattle or bead. In one embodiment, the additional wire further includes a spacer, such as a tube which at least partially surrounds a length of the additional wire. The spacer may be plastic, metal, or any other suitable material. The spacer may aid in keeping the rattle located generally in a single position or within a range of locations on the additional wire, such as where the spacer prevents sliding of the rattle along the additional wire. The spacer may also be sized so as to maintain a desired distance between the rattle and the blade. A rattle or other element may also thread onto or into the spacer. The additional wire may also include an additional ball or other feature with a size or shape configured to restrict motion of the wire through the associated opening in the blade. In such a way, a pivot arm may be rotatably connected to the blade, while features on either end of the opening in the blade prevent or at least partially resist motion of the pivot arm through the opening beyond a desired amount, such as to restrict a rattle or other components to only one side of the blade. It should be understood that another type of elongated member may be used in place of the additional wire without deviating from the scope or intent of this disclosure.

In another embodiment, the additional wire may include one or more further components proximal to the end of the additional wire which is distal from the blade, such as additional blades or “flutters”. The further components may include reflective components, features, or coatings. These further components may simulate the appearance or motion of fish as well as specific features of fish, such as scales or eyes. A school of fish may also be simulated by such further components. The reflective components may be any of a range of shapes, such as oval, triangular, elliptical, rectangular, or leaf-like, and may be substantially planar or curved. The further components may be attached to the additional wire so as to spin or at least partially rotate. The further components may also be attached so as to create a flutter motion, which may be more realistic in simulating fish or other prey. Larger additional components may create an impact or sound while moving in the water, and may create a reflective flash, which may be attractive to certain desired fish.

The disclosure relates to an improved fishing lure device and method of use, such as through the use of the described invention. The method may include the use of a fishing lure which may include one or more of the features or components described herein. Any number of components or features may be used in conjunction with the blade described, and various means for simulating the appearance or other sensory stimuli created by one or more fish may be incorporated. Various materials, including metals, plastics, and composites, may be used for the described components and features.

It is to be understood that the above mentioned features and the features yet to be explained hereinafter can be used not only in the respectively mentioned combinations but also in other combinations or alone without departing from the context of the present invention.

### BRIEF DESCRIPTION OF THE DRAWINGS

The invention is now disclosed in detail with reference to exemplary embodiments shown in the accompanying drawings, where:

FIG. 1 shows a front top isometric view of an embodiment of the fishing lure device of the present disclosure;

FIG. 2 shows a side view of the embodiment of the fishing lure device of FIG. 1;

FIG. 3 shows a front top isometric view of an embodiment of the blade component of the fishing lure device of the present disclosure;

FIG. 4 shows a rear top isometric view of the embodiment of the blade component of FIG. 3;

FIG. 5 shows a partially sectioned side view of an embodiment of the fishing lure device of the present disclosure;

FIG. 6 shows a front top isometric view of an alternate embodiment of the fishing lure device the present disclosure, with part of the lure body component removed;

FIG. 7 shows a front top isometric view of another alternate embodiment of the fishing lure device of the present disclosure;

FIG. 8 shows a front bottom isometric view of an alternate embodiment of the fishing lure device of the present disclosure;

FIG. 9 shows a side view of the embodiment of the fishing lure device of FIG. 8;

FIG. 10 shows a rear top isometric view of an alternate embodiment of the fishing lure device of the present disclosure;

FIG. 11 shows an alternate side view of the embodiment of the fishing lure device of FIG. 10;

FIG. 12 shows a front top isometric view of an embodiment of the blade component of the fishing lure device of the present disclosure; and

FIG. 13 shows a side cross-sectional view of the blade component of the fishing lure device of FIG. 12.

### DETAILED DESCRIPTION

Exemplary embodiments of the disclosure are illustrated in the Figures and are explained in the following description in more detail, wherein identical reference numbers refer to identical, or similar, or functionally identical or similar components.

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features or those previously described are omitted or simplified in order not to obscure the illustrative embodiments.

Various operations may be described as multiple discrete operations, in turn, in a manner that is most helpful in understanding the present invention, however the order of description should not be construed as to imply that these operations are necessarily order dependent. In particular, these operations need not be performed in the order of presentation. In some instances, structures and devices may be shown in block diagram or flow chart form in order to facilitate describing the disclosed subject matter.

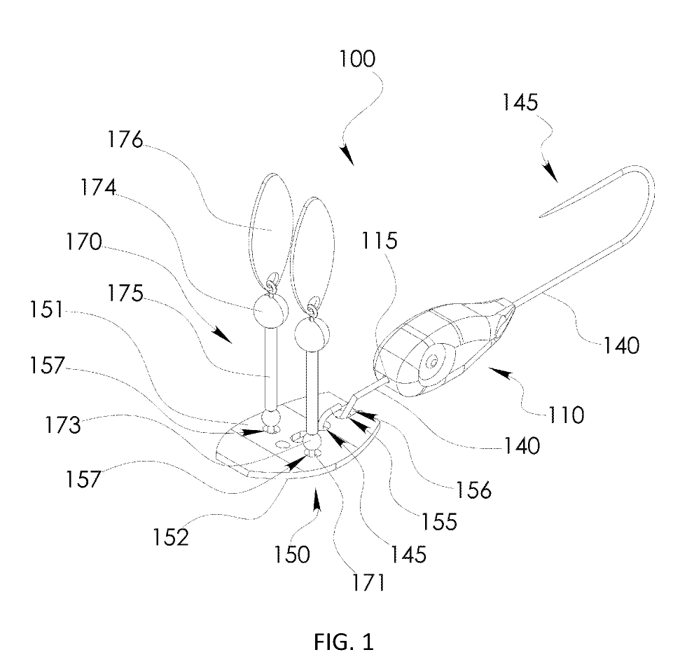

FIG. 1 shows a front top isometric view of an embodiment of the fishing lure device 100 of the present disclosure, generally referred to herein as a lure 100. In one embodiment, the lure 100 may include a lure body 110, such as an elongated body 110. The lure body 110 may be substantially cylindrical, rectangular in cross-section, hexagonal in cross-section, octagonal in cross-section, or any other shape which may be appropriate or understood by one skilled in the art. The lure body 110 may be a weighted mass or may be a container with a weighted mass inside. The lure body 110 may also be configured so as to imitate the shape or appearance of a fish or prey or other food for a fish. The lure body 110 may be substantially solid or it may be at least partially hollow.

The lure body 110 may also define an inner chamber 120 or a channel 130 configured to receive a wire 140 or other elongated member, or both a channel 130 and an inner open volume 120. It is understood that the lure body 110 may be a single component, or it may include subcomponents, such as body pieces, hooks, simulated eyes or scales, coatings, or other means of attracting or retaining desired fish or further supporting or retaining additional components. The lure body 110 itself may also comprise multiple components, such as being assembled from two or more subcomponents which are assembled so as to retain other components at least partially within the lure body 110, such as within the inner chamber 120. The wire 140 may pass at least partially through the lure body 110, entering through an entrance opening 115 defined by the lure body 110 through a front surface or other surface located proximal to the front of the lure body 110, such as a top, bottom, curved, or angled surface. The wire 140 may be retained within the lure body 110, and it may also extend out through an exit opening 116 defined by a side, top, bottom, or rear surface of the lure body 110. Where the wire 140 exits from the lure body 110, it may be further bent and may also have an at least partially sharp or pointed end 145, such as for forming a hook 145.

The wire 140 may extend generally away from the front portion of the lure body 110 and may be at least partially rotatably connected to a blade 150. The blade 150 may be substantially planar, though it may also be bent or curved or otherwise include features outside of the primary plane of the blade 150. The wire 140 may connect to the blade 150 through one or more openings 155 defined by the blade 150 and passing through between an upper or top surface 151 of the blade 150 and a lower or bottom surface 152 of the blade 150. In the embodiment shown in FIG. 1, the wire 150 passes through a first opening 155 defined by the blade 150 and then bends back through a second opening 155 defined by the blade 150. The wire 140 may thus at least partially rotate up and down relative to the blade 150. If the wire 140 is undersized relative to the first opening 155 or the second opening 155, then it may also be able to at least partially rotate side to side relative to the blade 150, thus enabling an oscillating motion of the lure body 110 relative to the blade 150. The blade 150 may further feature a recess or indentation 156 proximate to the first opening 155 or the rear area of the blade 150, enabling the wire 140 to seat substantially within the primary plane of the blade 150 as it extends away from the blade 150 and towards the lure body 110. This may allow the blade 150 and lure body 110 to remain substantially in line relative to the wire 140 and the primary plane of the blade 150.

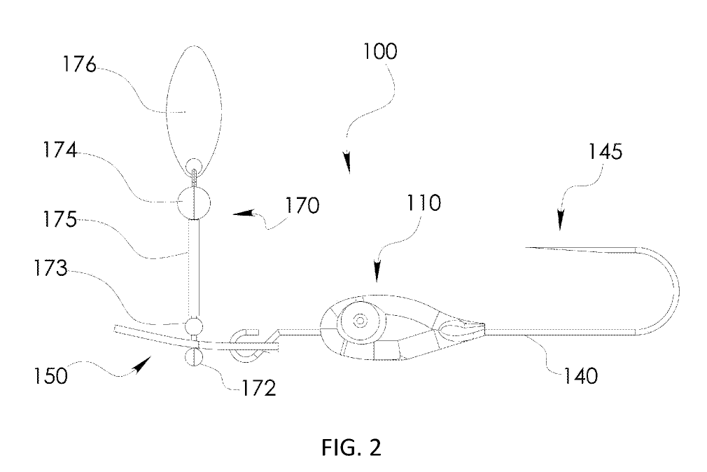

The blade 150 in the embodiment shown in FIG. 1 further defines a third and fourth opening 157 which are each configured to receive a pivot arm 170. The pivot arm 170 may be a substantially elongated body, may be another shape which may be appropriate for this application, may consist of a wire 171, or may comprise a combination of such shapes and one or more wires 171. The wire 171 may have a ball 172 at one end to aid in retaining the pivot arm 170 in connection to the blade 150. It is understood that other retention means may also be used, such as an eyelet or loop. The pivot arm 170 is able to pivot or at least partially rotate in at least one plane relative to the blade 150. The pivot arm 170 may include a second ball 173 or other feature configured to prevent or restrict motion of the pivot arm 170 in at least one direction, such as limiting translation of the pivot arm 170 through its associated opening 157 in the blade 150. The pivot arm 170 may further include a bead or rattle 174 at an end or otherwise distanced from the blade 150. The rattle 174 may be permanently attached to the pivot arm 170 or may be removable. The pivot arm 170 may also include a spacer 175, such as a tube 175 which fits over the wire 171. This may aid in retaining the rattle 174 in place or within a general range of locations or positions on the pivot arm 170, or it may aid in keeping the rattle 174 at a desired minimum distance from the blade 150. The pivot arm 170 may also include additional features, such as a flutter 176 which may optionally be configured to oscillate relate to the blade 150 or relative to the pivot arm 170 and may be made of a reflective material or coated in a reflective substance so as to simulate scales or eyes of a fish. FIG. 2 shows a side view of the embodiment of FIG. 1, including the ball 172 which aids in retaining the pivot arm 170 relative to the blade 150.

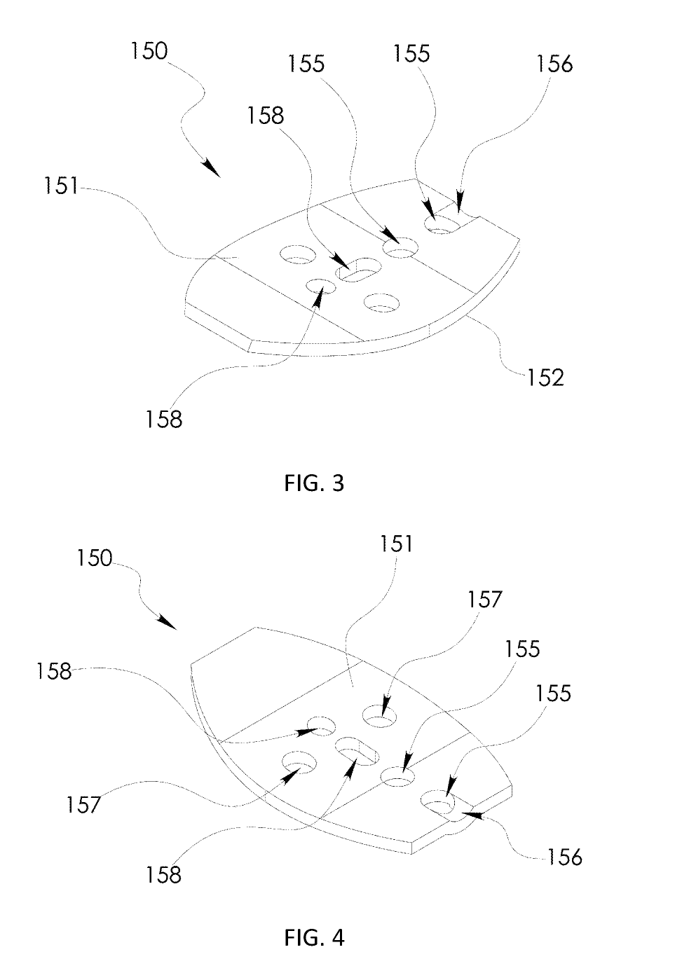

An embodiment of a blade 150 of the lure device 100 is shown in FIGS. 3 and 4. Material may be removed or an indentation, recess, cutaway, or curve 156 may be created by other means, such as by pressing into the blade 150 proximate to the first opening or the rear area of the blade 150. The indentation 156 may allow for movement of a wire 140 relative to the blade 150 and may allow for orientation of a proximal portion of a wire 140 close to or substantially within the primary plane of the blade 150. The indentation 156 may be formed when the blade 150 is stamped out of or machined from a material, such as steel or aluminum, may be bent after initial production, may be molded, or may be formed by other means known in the art. The blade 150 may be made of a range of materials, such as plastic, metals, composites, or combinations thereof, and may also have a coating, such as paint or a layer to aid in preventing rusting of the blade 150.

The blade 150 may define one or more openings 155 configured to receive a wire 140 or a feature connected to a wire 140. In the embodiment shown, the blade 150 includes two openings 155, so that a wire 140 may pass through the first opening 155 and loop back to pass through the second opening 155. It should be understood that the blade 150 may include more openings 155 or less openings 155, such as where a wire 140 only passes through a single opening 155 and is retained by a loop, ball 146, or other feature at an end of the wire 140. The blade 150 may also optionally include one or more additional openings 158, such as for the attachment of additional elements to the blade 150, such as hooks or loops 180, or for the attachment of a fishing line.

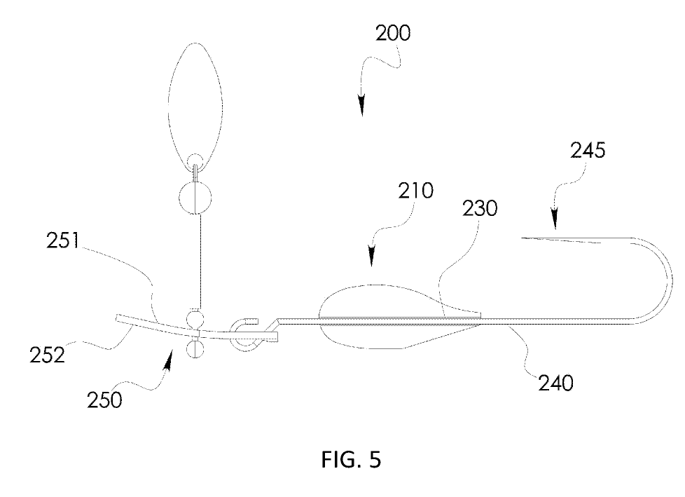

FIG. 5 shows a side view of an embodiment of the lure device 200, with a portion of the lure body 210 removed. A wire 240 may pass through a channel 230 defined by the lure body 210 so that at least one hook feature 245 of the lure device 200 may be unitary with the wire 240 which connects to the blade 250, or may be connected so that, even if the lure body 210 breaks or is damaged, the hook 245 may remain attached to the blade 250.

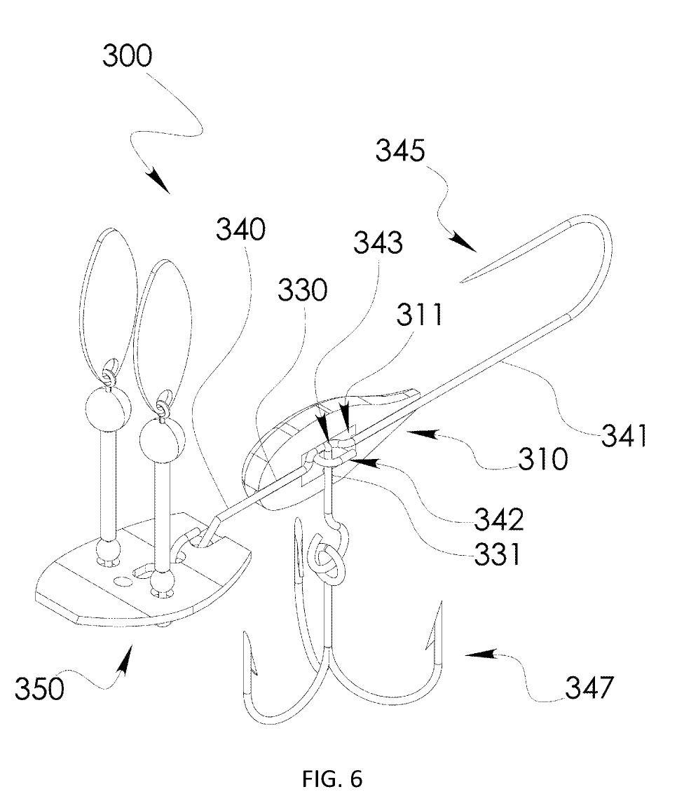

FIG. 6 shows another embodiment of the lure device 300, with a portion of the lure body 310 removed. The primary wire 340 may pass through a channel 330 and into an open volume 311 defined by the lure body 310. A secondary wire 341 or hook 345, or combination of the two, may connect or interface with the primary wire 340, such as forming a loop or eyelet 342 through which the primary wire 340 passes. The primary wire 340 may extend through a channel 331 out of the lure body 310 or may terminate as an anchoring feature for one or more additional wires 341. The primary wire itself may form a loop, eyelet, or may include a bend 343 or other feature to aid in restricting the motion of one or more additional wires 341 in at least one direction. In the embodiment shown, the primary wire 340 bends and exits from the lure body 310. One or more hooks 347 may also be connected to the primary wire 340 or to an additional wire 341.

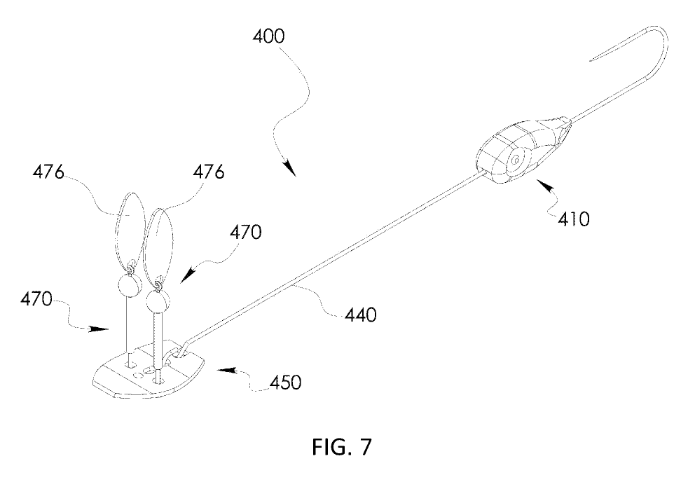

An alternate embodiment of the lure device 400, where the wire 440 is configured to be of sufficient length to, along with the lure body 410 and any additional elements, simulate the size of either a large fish or a school of fish, is shown in FIG. 7. The use of flutters 476 attached to the blade 450 may further aid in simulating a larger fish or a larger grouping of fish. This embodiment does not include a second ball on each pivot arm 470, though they may be included, as it may be desirable for some target prey for the lure device 400 to simulate more or less motion of one or more pivot arms 470.

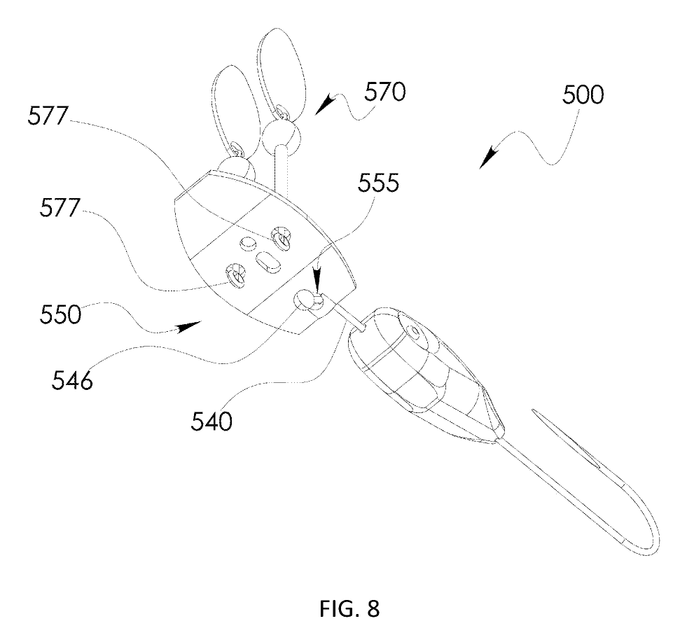

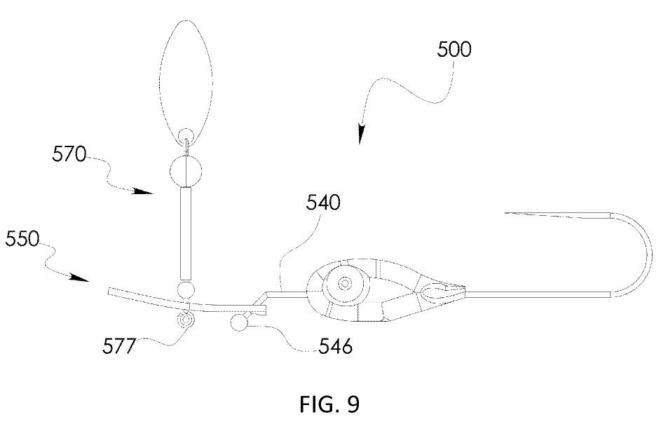

FIGS. 8 and 9 show an embodiment of the lure device 500 where the wire 540 may pass through only one opening 555 defined by the blade 550. The wire 540 may also not bend to create a loop in order to be retained relative to the blade 550, but may have a ball feature 546, a conical feature, eyelet, or other retention means. As shown in this embodiment, the pivot arms 570 may also be retained in connection to the blade 550 with a loop, eyelet 577, bent wire feature, or other features or elements which may at least partially restrict translation of the pivot arm 570 relative to the blade 550.

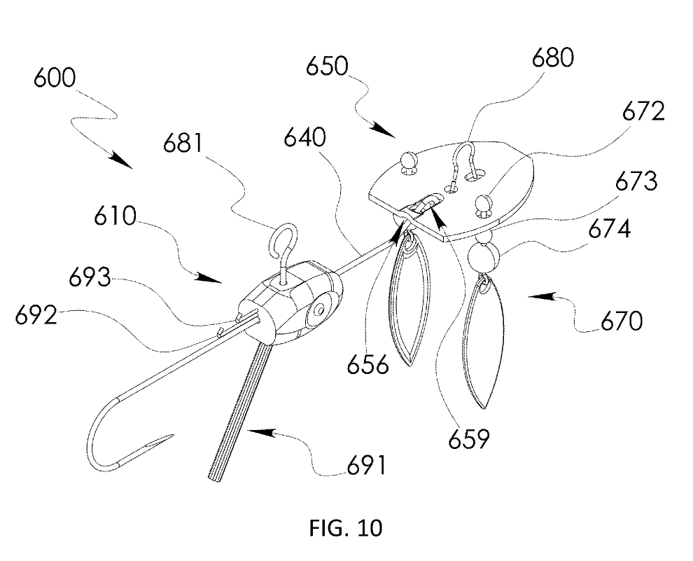

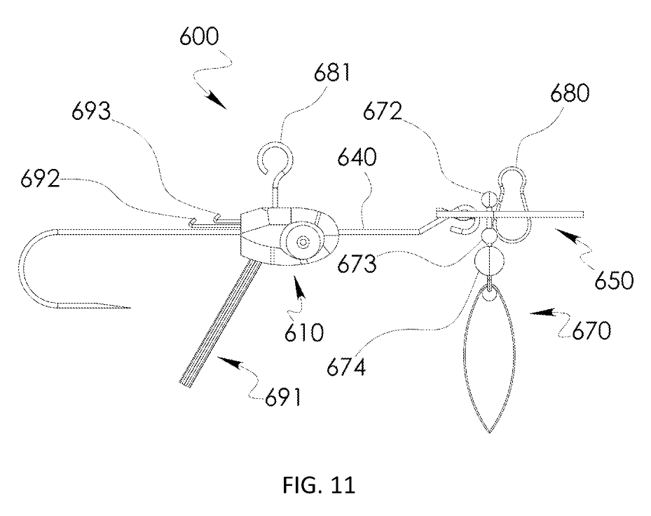

An alternate embodiment of the lure device 600 is shown in FIGS. 10 and 11. The blade 650 may include a loop 680 or other feature for the attachment of additional elements to the blade 650 or for the attachment of a fishing line. The loop 680 or other attachment feature may be unitary with the blade 650, permanently attached, or removably attached to it. The lure body 610 may also include an optional loop or hook 681 for the attachment of additional elements. As shown in this embodiment, the blade 650 may be substantially flat relative to and within its primary plane and may not include any bends, though such features may optionally be included. The blade 650 may include a first recess 656 to allow the wire 640 to sit closer to or within the primary plane of the blade 650. The blade 650 may also include a second recess 659 with may allow a bend or other retention feature in or attached to the wire 640 to sit closer to or within the primary plane of the blade 650. The first recess 656 and the second recess 659 may be in different or opposing surfaces of the blade 650. Motion and positioning of the blade 650 relative to the wire 640 and the lure body 610 which is enabled by the use of a first recess 656 or a second recess 659 may also allow for smaller connection holes in the blade 650 than through the use of means such as split rings or other joint features in the wire 640 without introducing potential failure points or so as to decrease them.

In the embodiment of the lure device 600 shown, the pivot arms 670 do not include a spacer. A pivot arm 670 may include a first ball 672, bead, or other retention feature or element to restrict translation of the pivot arm 670 in at least one direction relative to the blade, 650. In one embodiment, the ball 672 will aid in retaining the pivot arm 670 to the blade 650 while allowing at least some rotation of the pivot arm 670. The pivot arm may also include a second ball 673, bead, or other retention feature or element on an opposing side of the blade 650, such as to further at least partially restrict or limit translation of the pivot arm 670 relative to the blade 650. Either the first ball 672, the second ball 673, or an additional ball or bead 674 may also function as a rattle or contain further elements to make rattling noises or vibrations when moving or fluttering so as to attract fish.

The lure device 600 may also include a skirt or weed guard 691, which may be formed of a single piece of material or multiple pieces of material, such as at least partially flexible filaments. The weed guard 691 may create an overall larger appearance of the lure device 600 to predators. The weed guard 691 may also imitate features or profiles of certain desirable prey, such as crawfish.

The lure device 600 may include a skirt collar to aid in retaining rubber bands or other elements to the lure body 610 or to a wire 640. The lure device 600 may also include at least one wire keeper 692 and may optionally include a second wire keeper 693 or more. The use of at least one wire keeper 692, 693 may remove the need for a joint for connecting a skirt collar. The one or more wire keepers 692, 693 may be attached externally to the lure body 610, internally to the lure body 610, or may be molded into the lure body 610.

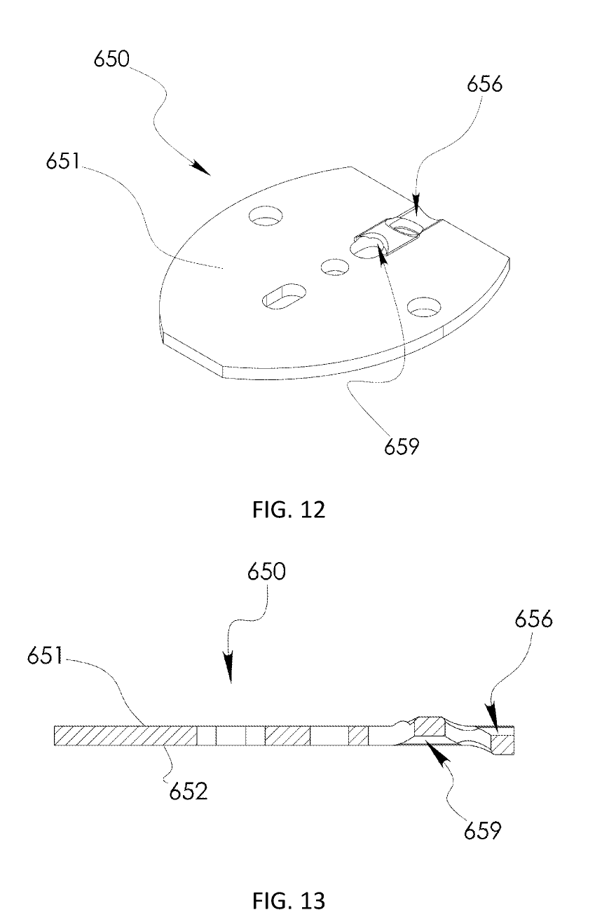

FIGS. 12 and 13 show an isometric view and a cross-sectional side view, respectively, of a blade 650 of the present disclosure. In the embodiment shown, the top surface 651 of the blade 650 includes a first recess 656, while the bottom surface 652 of the blade 650 includes a second recess 659.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention. Accordingly, various modifications, adaptations, combinations, and alternatives may occur to one skilled in the art without departing from the spirit of the invention and scope of the claimed coverage.

What is claimed is:

1. A fishing lure, comprising:
an elongated member, defining a substantially longitudinal axis and further comprising a first end, a second end, a first width substantially perpendicular to the substantially longitudinal axis, and a first connection feature; and
a blade member, further comprising a first surface, a second surface, and a second connection feature;
wherein the blade member defines a first opening extending between the first surface and the second surface, at least a portion of the elongated member passes at least partially through the first opening, the elongated member is at least partially rotatably connected to the blade member by means of the first connection feature and the second connection feature, and further wherein the first surface comprises a first recess configured to receive at least a first portion of the elongated member.

2. The fishing lure according to claim 1, further wherein the second surface comprises a second recess configured to receive at least a second portion of the elongated member.

3. The fishing lure according to claim 1, further wherein the first connection feature has a second width which is greater than at least a portion of the first width of the elongated member.

4. The fishing lure according to claim 1, further comprising a lure body having a third surface and a fourth surface, wherein the lure body defines a first channel configured to receive at least a second portion of the elongated member.

5. The fishing lure according to claim 4, further wherein the first channel extends between the third surface and the fourth surface and the elongated member is configured to at least partially pass through the lure body through the first channel from the third surface to the fourth surface, and further wherein the elongated member comprises a hook feature proximate to the second end and closer to the fourth surface than to the third surface.

6. The fishing lure according to claim 1, further wherein the blade member defines a second opening extending between the first surface and the second surface and at least a second portion of the elongated member passes at least partially through the second opening, and further wherein the first retention feature is proximal to the first end and configured to resist motion of the elongated member in at least one direction relative to the blade member.

7. The fishing lure according to claim 1, further comprising a third opening defined by the blade member and configured to receive a pivot member.

8. The fishing lure according to claim 7, further wherein the third opening extends between the first surface and the second surface.

9. The fishing lure according to claim 7, further comprising at least one pivot member having a third end and a fourth end and further wherein the at least one pivot member is at least partially rotatably connected to the blade member.

10. The fishing lure according to claim 7, further wherein the at least one pivot member comprises a third retention feature proximal to the third end and configured to resist motion of the at least one pivot member in at least one direction relative to the blade member.

11. The fishing lure according to claim 10, further wherein the at least one pivot member further comprises a rattle element proximal to the fourth end.

12. The fishing lure according to claim 10, further wherein the at least one pivot member is removably connected to the blade member.

13. The fishing lure according to claim 11, further wherein the rattle element is removably connected to the at least one pivot member.

14. The fishing lure according to claim 11, further wherein the at least one pivot member further comprises a spacer configured to resist translation of the rattle element relative to the at least one pivot member.

15. The fishing lure according to claim 10, further wherein the at least one pivot member further comprises a flutter element which is at least partially rotatably connected to the pivot element.

16. A fishing lure, comprising:
an elongated member, having a first end and a second end;
a blade member, having a first surface and a second surface; and
a lure body, having a third surface and a fourth surface and defining a channel extending through the lure body from the third surface to the fourth surface;
wherein the blade member defines a first opening extending between the first surface and the second surface, and further wherein the elongated member is at least partially rotatably connected to the blade member proximal to the first opening and at least partially passes through the first opening, and further wherein the first surface defines a recess configured to receive at least a portion of the elongated member.

17. The fishing lure according to claim 16, further wherein the elongated member further comprises a retention feature configured to be at least partially retained by the first opening.

18. The fishing lure according to claim 16, further wherein the blade member defines a second opening extending between the first surface and the second surface, and the elongated member further comprises an at least partial loop feature configured to be at least partially retained by the blade member proximal to the first opening and the second opening.

19. The fishing lure according to claim 16, further comprising a pivot member, and further wherein the blade member further comprises a third opening configured to receive the pivot member and the pivot member is at least partially rotatably connected to the blade member, and further wherein the pivot member comprises a flutter element which is at least partially rotatably connected to the pivot member.

20. A method of using a fishing lure, comprising:
attaching a fishing line to a blade element;
attaching a wire to the blade element;
attaching a lure body to the wire; and
attaching a pivot arm to the blade element;
wherein the wire further comprises a first end and a second end, the wire is at least partially rotatably connected to the blade element proximal to the first end, the pivot arm is at least partially rotatably connected to the blade element, the wire comprises a hook feature proximal to the second end, and the blade element defines at least one recess configured to at least partially receive at least a portion of the wire element.
